(19) United States
(12) Patent Application Publication
(10) Pub. No.: US 2003/0171154 A1
(43) Pub. Date: Sep. 11, 2003

(54) Propeller shaft assembly

(75) Inventors: Louis M. Farrace, Huntington Woods, MI (US); Salvatore Leone, Shelby Twp., MI (US); Albert Darby Webb, Rochester, MI (US); Ramon C. Kuczera, Clarkston, MI (US)

Correspondence Address: Mick A. Nylander, 3300 University Drive, Auburn Hills, MI, 48326-2362, US

(73) Assignee: GKN Automotive, Inc.

(21) Appl. No.: 10/093,573

(22) Filed: Mar. 8, 2002

(51) Int. Cl. F16C 1/26; F16D 3/84

(52) U.S. Cl. 464/178

(57) ABSTRACT

An improved propeller shaft assembly includes a first propeller shaft section having a first plunging joint affixable thereto, a second propeller shaft section having a second plunging joint affixable thereto, and a connecting member coupled with the first and second plunging joints.

### TECHNICAL FIELD

The present invention relates to a drive system for a motor vehicle and, more specifically, to a crash optimized propeller shaft assembly adapted to inhibit damage to the motor vehicle in the event of an accident.

### BACKGROUND ART

There are generally four (4) main types of automotive drive line systems. More specifically, there exists a full-time front wheel drive system, a full-time rear wheel drive system, a part-time four wheel drive system, and an all-wheel drive system. Most commonly, the systems are distinguished by the delivery of power to different combinations of drive wheels, i.e., front drive wheels, rear drive wheels or some combination thereof. In addition to delivering power to a particular combination of drive wheels, most drive systems permit the respectively driven wheels to rotate at different speeds.

Drive wheel systems can also include one or more constant velocity joints (CVJ's). Such joints are well known in the art and are employed where transmission of a constant velocity rotary motion is desired or required. For example, the tripod joint is characterized by a bell-shaped outer race (housing) disposed around an inner spider joint which travels in channels formed in the outer race. The spider-shaped cross section of the inner joint is descriptive of the three equispaced arms extending therefrom which travel in the tracks of the outer joint. Part spherical rollers are featured on each arm.

One common type of constant velocity universal joint is the plunging tripod type, characterized by the performance of end motion in the joint. Plunging tripod joints are currently used for inboard (transmission side) joint in front wheel drive vehicles, and particularly in the propeller shafts found in rear wheel drive, all-wheel drive and 4-wheel drive vehicles. Another common feature of tripod universal joints is their plunging or end motion character. Plunging tripod universal joints allow the interconnection shafts to change length during operation without the use of splines which provoke significant reaction forces thereby resulting in a source of vibration and noise. The plunging tripod joint accommodates end wise movement within the joint itself with a minimum of frictional resistance, since the part-spherical rollers are themselves supported on the arms by needle roller bearings.

Tripod constant velocity joints are generally grease lubricated for life and sealed by a sealing boot when used on some drive shafts. Constant velocity universal joints are usually sealed in order to retain grease inside the joint while keeping contaminants and foreign matter, such as dirt and water, out. In order to achieve this protection, the constant velocity joint is usually enclosed at the open end of the outer race by a boot made of rubber, thermoplastic or urethane. The opposite end of the outer race is either an enclosed “dome” of the bell-shaped housing, known in the art as the greasecap. Such sealing and protection of the constant velocity joint is necessary because, once the inner chamber of the outer joint is partially-filled and thus lubricated, it is generally lubricated for life and preferably requires no maintenance.

Another common type of constant velocity universal joint is the plunging VL or “cross groove” type, which consists of an outer and inner race drivably connected through balls located in circumferentially spaced straight or helical grooves alternately inclined relative to a rotational axis. The balls are positioned in a constant velocity plane by an intersecting groove relationship and maintained in this plane by a cage located between the two races. The joint permits axial movement since the cage is not positionably engaged to either race. As those skilled in the art will recognized, the principal advantage of this type of joint is its ability to transmit constant velocity and simultaneously accommodate axial motion. Plunging VL constant velocity universal joints are currently used for halfshafts in front and rear drive vehicles, and particularly in the propeller shafts found in rear wheel drive, all-wheel drive and four-wheel drive vehicles.

A typical driveline system can incorporate one or more of the above constant velocity universal joints to connect a pair of propeller shafts (front and rear) to a power take off unit and a rear drive line module, respectively. These propeller shafts (“propshafts”) function to transfer torque to the rear axle in rear wheel and all wheel drive vehicles. The propshafts are typically rigid in the axial directions and under certain circumstances, can contribute to the transfer of force down the fore-to-aft axis of the vehicle on impact, particularly in a frontal crash. Such transfer of energy can lead to high forces in the vehicle and thus high rates of acceleration for the occupants. Further, such energy may contribute to uncontrolled buckling of the propshaft itself resulting in damage to the passenger compartment or fuel tank from puncturing or the like.

Consequently, a need exists for an improved propeller shaft assembly which addresses and solves the aforementioned problems.

### DISCLOSURE OF INVENTION

It is a principal object of the present invention to provide an improved propeller shaft assembly operative to inhibit damage to a motor vehicle in frontal or rear impact.

It is a further object of the present invention to provide an improved propeller shaft assembly which functions to prevent uncontrolled buckling of the assembly and resultant damage to the vehicle passenger compartment and/or fuel tank.

In carrying out the above object, there is provided a multi-piece crash optimized propeller shaft assembly. The assembly comprises a first (rear) section and a second (front) section which function to couple a rear driveline module to a power take off unit in a motor vehicle. In keeping with the invention, the first section has a first end affixable to the drive line module and a second end affixable to a first plunging constant velocity joint. The second section has a first end affixable to the power take-off unit and a second end affixable to a second plunging constant velocity joint. A connecting member is affixable between the first and second plunging joints such that the joints are oriented in opposite directions once the propeller shaft is assembled. In a preferred embodiment, the connecting member is a center bearing affixable to the motor vehicle by a suitable bracket.

These and other objects features and advantages of the present invention will become more readily apparent with reference to the following detailed description of the invention wherein like reference numerals correspond to like components.

### BRIEF DESCRIPTION OF DRAWINGS

FIG. 1 is a perspective view of a representative drive line system adapted to receive the improved propeller shaft assembly of the present invention.

FIG. 2 is a diagrammatical depiction of a drive line system of a motor vehicle.

FIG. 3 is a perspective view of the propeller shaft assembly of the present invention.

FIG. 4 is an enlarged partially cross sectional view of a plunging tripod type constant velocity joint.

FIG. 5 is a side sectional view of an outer race or of the tripod-type constant velocity joint in one of a static state or in a state operating below a predetermined threshold.

FIG. 6 is a sectional view of the constant velocity joint along line 6-6 of FIG. 5.

FIG. 7 is a side sectional view similar to that shown in FIG. 5 but illustrating the tripod-type constant velocity joint in a state operating above a predetermined threshold.

FIG. 8 is partial side sectional view of the constant velocity joint of FIGS. 4-8 illustrating the inner joint assembly; and

FIG. 9 is a sectional view of the constant velocity joint of FIGS. 4-8 illustrating the inner joint, outer joint and joint cavity, taken along line 9-9 of FIG. 8.

FIG. 10 is an enlarged partially cross sectional view of a plunging VL type constant velocity joint.

FIG. 11 is an enlarged partially cross sectional view of an outer race for use with the plunging joint of FIG. 10.

FIG. 12 is an enlarged partially cross sectional view of an alternative outer race for use with the plunging joint of FIG. 10.

FIG. 13 is an enlarged partially cross sectional view of an alternative outer race for use with the plunging joint of FIG. 10.

FIG. 14 is an end view of a cross groove joint for the outer races of FIGS. 11-13.

FIGS. 15-20 are diagrammatical depictions of the functionality of the propeller shaft assembly sections during impact.

FIG. 21 is a graph illustrating Compression Load and Compression Distance in accordance with the present invention.

### BEST MODE FOR CARRYING OUT THE INVENTION

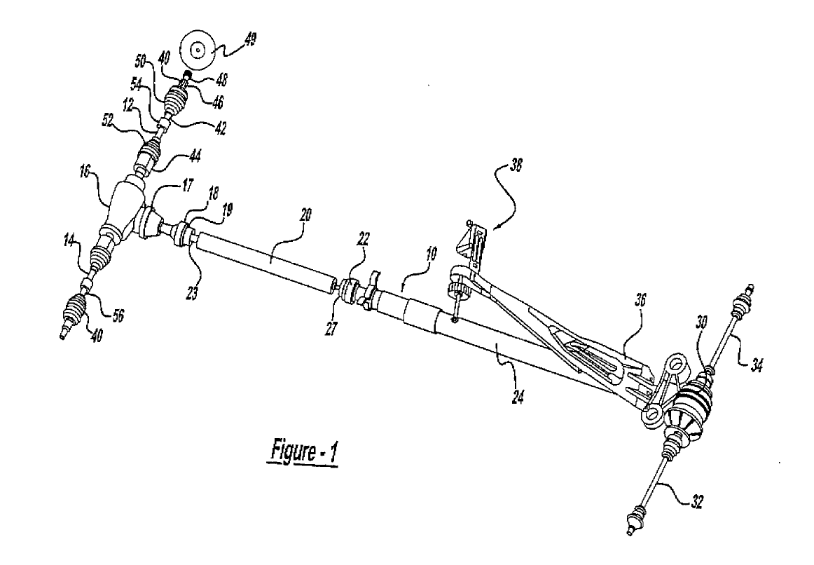

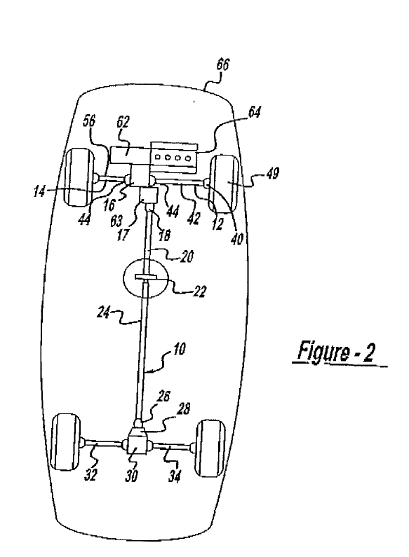

Referring to FIGS. 1 and 2 there is shown a representative drive line system of a motor vehicle designated generally by reference numeral 10. Drive system 10 comprises a pair of front half shaft assemblies designated as reference numerals 12 & 14 respectively. The front half shaft assemblies 12 & 14 are operatively connected to a front differential 16. Connected to front differential 16 is a power take-off unit 17. The power take-off 17 is operatively connected to a high speed fixed joint 18. Operatively connected to high speed fixed joint 18 is a front propeller shaft (“propshaft”) assembly 20. Operatively connected to front propshaft assembly 20 is a constant velocity joint designated as reference numeral 22. Connected to constant velocity joint 22 is rear propshaft assembly 24. Rear propshaft assembly 24 is connected on one end to cardan joint assembly 26. Cardan joint assembly 26 may be operatively connected to a speed sensing torque device 28. Speed sensing torque transfer device 28 is operatively connected to a rear differential assembly 30. A pair of rear half shaft assemblies 32 & 34 are each connected to rear differential assembly 30. As shown in FIG. 1, attached to the rear differential assembly 30 is torque arm 36. Torque arm 36 is further connected to torque arm mount 38.

Front half shaft assemblies 12 & 14 are comprised of fixed constant velocity joints 40, a interconnecting shaft 42 and a plunge style constant velocity joint 44. Plunge style constant velocity joints 44 are operatively connected to the front differential 16. Plunge style constant velocity joints 44 are plug-in style in this embodiment. However, any style of constant velocity joint half shaft assembly may be used depending upon the application. As shown in FIG. 1, the stem portion 46 is splined such that it interacts with a front wheel of a motor vehicle and has a threaded portion 48 which allows connection of the wheel 49 to the half shaft assembly 12.

There is also shown in FIG. 1 constant velocity joint boots 50 & 52 which are known in the art and are utilized to contain constant velocity joint grease which is utilized to lubricate the constant velocity joints. There is also shown an externally mounted dynamic damper 54 which is known in the art.

Halfshaft assembly 14 may be designed generally similar to that of halfshaft assembly 12 with changes being made to the length of interconnecting shaft 56. Different sizes and types of constant velocity joint may also be utilized on the left or right side of the drive system depending on the particular application.

The power take-off unit 17 is mounted to the face of the transmission 62 and receives torque from the front differential 16. The transmission 62 is operatively connected to the engine 64 of the motor vehicle. The power take-off unit 17 has the same gear ratio as the rear differential 30 and drives the front propshaft 20 through the high speed fixed joint 18 at 90 degrees from the front differential axis.

Still referring to FIGS. 1 and 2, in a typical four-wheel drive vehicle, the drive from transfer case 12 is transmitted to the front and rear final drive or differential units, 22 and 24, respectively, through two propeller shafts 20 and 24. In the drive system shown, an internal combustion engine 64 is operatively connected to a front wheel drive transmission system 62. Front halfshaft assemblies 12 and 14 are operatively connected to transmission system 62. More specifically, transmission system 62 includes a front differential 16 as is known in the art which includes some means for receiving the plunging constant velocity joints 44 of the front halfshaft assemblies. Internal to the transmission 62, the front differential housing 63 is operatively connected to the power take-off unit 17. The power take-off unit 17 is further connected to a high speed fixed joint 18.

A high speed fixed joint 18 is connected at one end to the power take-off unit 17 and at the other end to a front propshaft 20. Constant velocity joint 22 is similarly connected at one end to the rear propshaft 24 and at the other end to front propshaft 20. The high speed fixed joint may have a revolution-per-minute (RPM) capacity of 6000 RPMs with a preferable range of 3000-5000 RPMs, a torque capacity of 5-1500 Nm with a preferable capacity of 600-700 Nm, and an angle capacity of up to 15 degrees with a preferable capacity of 3-6 degrees. Of course, the drive system may use other constant velocity joints and/or cardan joints or universal joint technology at this connection. However, a high speed fixed joint is generally preferred.

High speed fixed joint 18 includes a boot 23 which is utilized to enclose grease (not shown) required for lubrication of the high speed fixed joint 18. The front propshaft 20 in the present invention is manufactured from steel providing a very low run-out and critical speed capacity higher than the second engine order. Front propshaft 20 is operatively connected to constant velocity joint 22 by fasteners (not shown) front propshaft 20 has a flange 27 extending out which is connected to constant velocity joint 22 by the above referenced fasteners. High speed fixed joint 18 similarly includes a flange 19 extending out which is connected to front propshaft 20 by fasteners.

As indicated above, propeller shafts (“propshafts”) 20 and 24 function to transfer torque to the rear axle in rear wheel and all wheel drive vehicles. These propshafts are typically rigid in the axial direction and under certain circumstances, can contribute to the transfer of force down the fore-to-aft axis of the vehicle on impact, particularly in a frontal crash. Such transfer of energy can lead to high forces in the vehicle and thus high rates of acceleration for the occupants. Further, such energy may contribute to uncontrolled buckling of the propshaft itself resulting in possible damage to the passenger compartment or fuel tank from puncturing or the like.

The present invention addresses the aforementioned possibilities by providing a propeller shaft assembly that maintains a high degree of stiffness, has a higher retention capability, and may be tunable to decouple from a motor vehicle in response to predetermined loads upon impact.

Referring to FIG. 3 there is shown a perspective view of the propeller shaft assembly of the present invention designated generally by reference numeral 60. Assembly 60 includes a first (rear) section 62 and a second (front) section 64, each operatively connected to one another to transfer torque from a rear drive line module e.g. cardan joint assembly 26 etc. to power take-off unit 17. More specifically, each of the propeller sections 62 and 64 includes a plunging constant velocity universal joint 66 affixable at one end. In keeping with the invention, the plunging constant velocity joints 66 are further affixable to one another so as to form the propeller shaft assembly 60. In further keeping with the invention, plunging joints 66 are oriented in the assembled position in opposing directions. That is, the plunging joints 66 directly face one another.

In a preferred embodiment, plunging joints 66 comprise tripod and/or VL type constant velocity joints and are affixable to one another via a suitable connecting member such as, for example, center bearing 68. However, it is understood that any suitable plunging constant velocity joint may be utilized depending on the application. Similarly, any suitable connecting member may be utilized including, without limitation, one or more flexible couplings, an additional propeller shaft section or sections as well as other joints and fasteners.

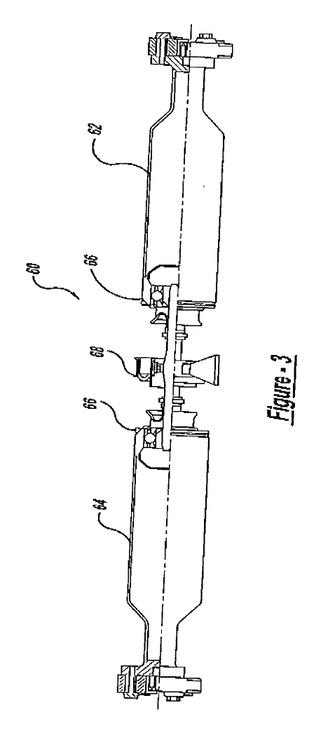

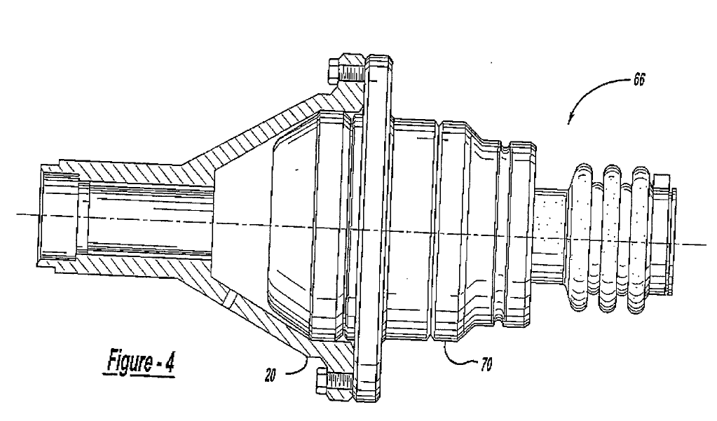

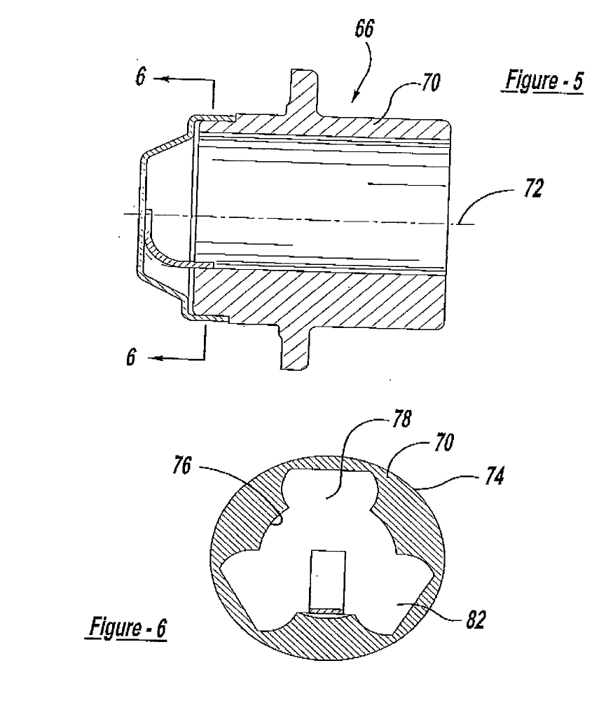

Turning now to FIGS. 4-9, the functionality of the plunging constant velocity joints of the present invention will be described in further detail. At the threshold, it is noted that constant velocity joint 66 illustrated in FIGS. 4-9 of the drawings and discussed herein is of the tripod-type plunging (or telescopic) variety. However, this type of constant velocity joint 66 is shown for illustrative and discussion purposes only, as it is contemplated that the teachings according to the present invention are applicable to any suitable plunging joint including, without limitation, a plunging VL type constant velocity joint.

Referring now to FIG. 4, illustrated therein is a cross-sectional view of the constant velocity joint 66 of FIG. 4. For ease of illustrating the teachings according to the present invention, constant velocity joint 66 of FIG. 4 is shown with housing 70 without an inner race (or inner joint) as is well known in the art in conjunction with constant velocity joints. As shown in FIGS. 4, 6, and 8-9, constant velocity joint 66 includes a substantially annular outer race 70 or housing. Outer race 70 is typically a bell shaped housing and is rotatable about an axis 72. Bell-shaped outer race 70 includes an outer surface 74, and an inner surface 76 which defines an inner cavity 78 within. Outer race 70 also includes a dome portion 80 which is commonly referred to in the art as a greasecap, best shown in FIGS. 4-5 and 7-8.

Referring now to FIGS. 8-9, cavity 78 has three longitudinal, equispaced and circumferentially distributed recesses 82 formed in interior surface 76 of outer race 70. Each recess 82 is longitudinally extending and is also generally parallel to axis 72. As is best shown in FIG. 9, each recess 82 forms a pair of longitudinal opposed tracks 84 which are also generally parallel to axis 72. Further included in tripod joint 66 is a substantially annular inner joint assembly 86 which is disposed within cavity 78 of outer race 70.

Inner joint assembly 86 includes an inner joint 88 (or spider joint), a propeller shaft 90 and a roller assembly 92. Inner joint 88 may be integral or separate with shaft 90. Inner joint assembly 86 has an opening 94 longitudinally therethrough for receiving a propeller shaft 90 which provides the rotational motion to be transmitted to the drive line.

Referring again to FIGS. 8-9 and as is best shown in FIG. 9, inner joint assembly 86 further has three circumferentially distributed radial cylindrical arms 96, which are generally offset by 120° and are connected to each other via inner joint 88. A boot 98 is also included as part of constant velocity joint 66. Boot 98 is a flexible cover made generally of elastomeric rubber, thermoplastic or urethane. Boot 98 shields inner cavity 78 of outer race 70 from contaminants and other foreign objects detrimental to the function of constant velocity joint 66.

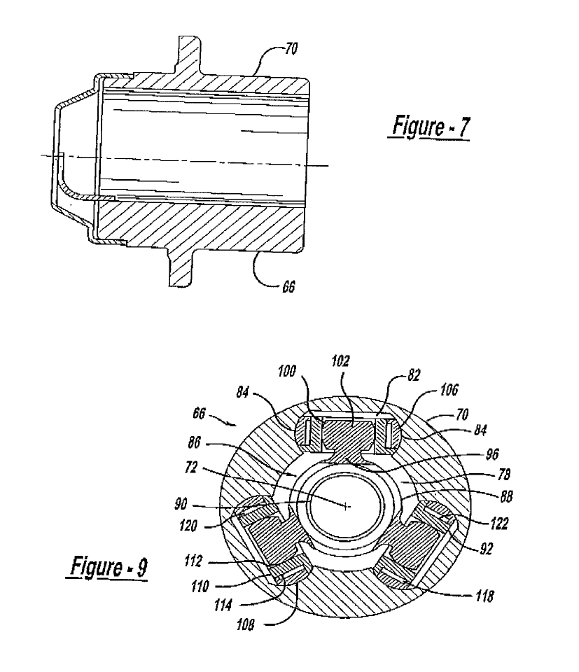

As discussed, inner joint assembly 86 has three equally circumferentially spaced and radial extending arms 96. Each arm 96 is adapted to extend into a corresponding recess 82 as shown in FIG. 9. As is well-known in the art, inner joint 88 is commonly referred to as having a spider-shaped or star-shaped cross section, due to its circumferentially, equally distributed, radially extending arms 96. Each arm 96 corresponds to and radially extends into respective recess 82 between oppositely disposed longitudinal tracks 84. Each recess 82 of outer race 70 is engaged by a corresponding arm 96. Depending on the variety of tripod joint, arm 96 may have a spherical outer surface 100 as shown in FIGS. 8-9. Of course, arm 96 may also have a cylindrical outer surface as do other types of plunging tripod joints well known in the art. In the embodiment shown in FIGS. 7-9, arm 96 may also be referred to as a trunnion 102, characterized by its partial spherical exterior surface portion 100.

Still referring to FIGS. 8-9, each trunnion 102 of inner joint 88 further includes a roller assembly 104 provided thereon. Each roller assembly 104 has a roller 106 (in the embodiment illustrated in FIGS. 8-9, outer roller 106 may be more descriptive). Roller 106 has an outer surface 108 rollingly engaged with a respective longitudinal track 84 of outer race 70. Each roller assembly 104 is axially and angularly movable relative to an arm 96 axis.

Again, it must be noted that there exists various types of tripod roller assemblies which may associate with a given inner joint arm, and just one of these designs is described herein for illustrative purposes only. It is fully intended that the invention herein should be applicable to any constant velocity joint. Specifically with regard to tripod universal joint 66 illustrated in FIGS. 4-9, each roller assembly 104 includes an annular roller carrier 110 (or inner roller) which contacts and is pivotally positioned on spherical outer surface 100 of trunnion 102. In FIGS. 8-9, outer roller 106 is rotatably held on roller carrier 110. As shown in FIG. 9, roller carrier 110 has a cylindrical inner face 112 to hold trunnion 102 so as to be articulatable and radially displaceable relative to trunnion 102.

Roller assembly 104 is positioned in sliding engagement with the partially spherical exterior surface portion 100 of trunnion 102. Each roller assembly 104 further includes a plurality of needle rollers 114 disposed between roller carrier 110 and outer roller 106. Roller carrier 110 and outer roller 106 are provided with flanges 116 and 118, respectively, which form a pocket to retain the plurality of needle rollers 114 without the use of snap rings. The plurality of needle rollers 114 (bearing means) are in rolling contact with inner cylindrical surface 120 of outer roller 106 and outer cylindrical surface 122 of roller carrier 110.

With constant velocity joint 66 rotating in the articulated condition, there occurs, with reference to inner joint assembly 86, a radially oscillating movement of rollers 106 relative to joint axis 72 and a pivoting movement of rollers 106 on arms 96. At the same time, with reference to outer race 70, there occurs longitudinally extending oscillating rolling movement of rollers 106 along tracks 84. The first mentioned radial and pivoting movements are accompanied by sliding friction. The next mentioned rolling movement predominantly occurs in the form of rolling contact movement.

As previously discussed, roller 106 engagingly rides on corresponding tracks 84 in each recess 82. Each longitudinal recess 82 traps roller assembly 104 in recess 82 and allows only movement of roller assembly 104 along a path which is generally parallel to axis 72. Skewing of roller assembly 104 relative to longitudinal track 84 is thus minimized. Each roller 106 is pivotable and radially displaceable relative to its respective trunnion 102. In the radial interior of roller assembly 104, the two halves of track 84 each include a shoulder of which, on the radial inside, supports roller 106. As was previously mentioned, inner surface 112 of roller carrier 110 is in sliding contact with the spherical exterior surface portion 100 of trunnion 102.

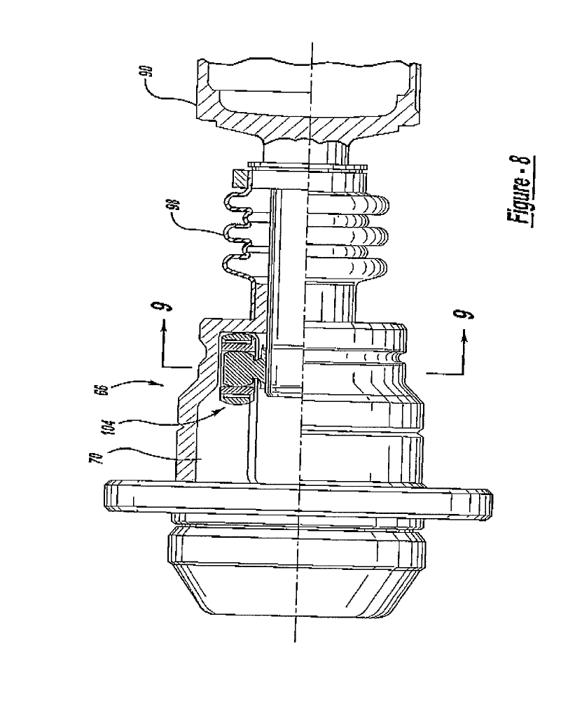

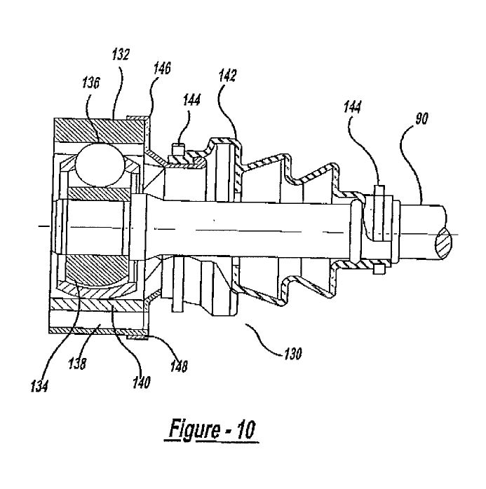

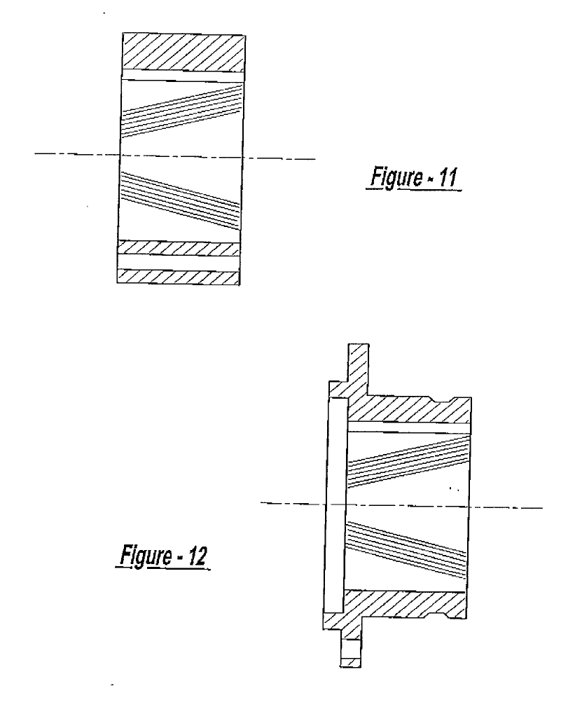

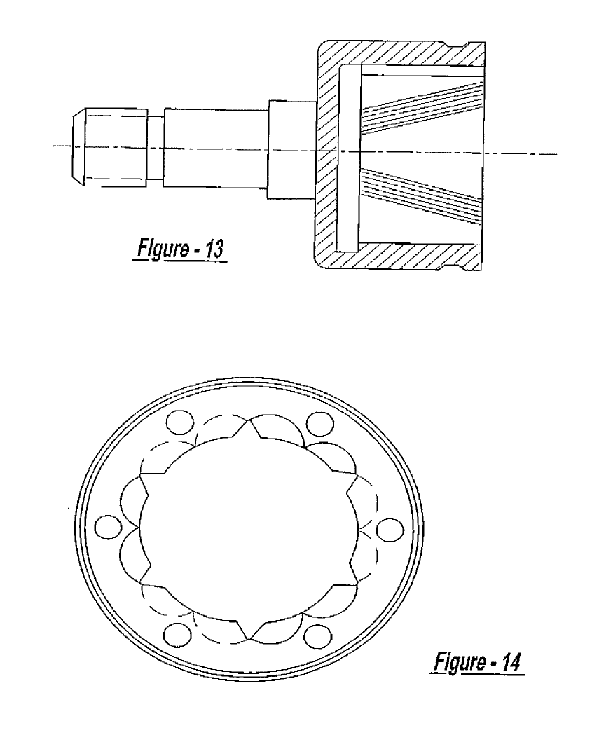

The operation of a suitable plunging VL type constant velocity joint may be better understood with reference to FIGS. 10-14. A cross groove (“VL” type) constant velocity universal joint is shown in FIG. 10 and designated generally by reference numeral 130. As indicated above, in a typical design, joint 130 is a constant velocity universal joint, radially self-supported, which consists of an outer race 132, and an inner race 134 drivably connected through balls 136 located in circumferentially spaced straight or helical grooves alternately inclined relative to the rotational axis 138. The balls 136 are positioned in the constant velocity plane by an intersecting groove relationship and maintained in this plane by a cage 140 located between the two races 132 and 134. The joint 130 permits axial movement since the cage 140 is not positionably engaged to either race 132 or 134.

As indicated above, the principal advantage of this joint is its ability to transmit constant velocity and simultaneously accommodate axial motion. Also, it is relatively economical to manufacture. A limitation of this joint is its generally smaller axial stroke capability when compared with some other end motion type joints.

In operation the cross groove joint 130 transmits true constant velocity and simultaneously permits axial motion. The same internal geometry which provides for angular motion also allows axial movement. The drive balls 136 are positioned in the constant velocity plane 138 by the action of the crossed circumferentially spaced and alternately inclined straight or helical ball grooves and maintained in this plane by cage 140.

When transmitting torque at an angle, a secondary couple is produced on both driving and driven members of the joint 130. As in all other ball type constant velocity joints which maintain driving contact through the constant velocity or bisecting angle plane, the couple forces react as static nonvibrating forces only on the bearing supports. The secondary couples are a function of the torque and joint angle only. These couples are of the same magnitude on both driving and driven members and are normal to the joint angle plane. For a given torque direction and disposition of the joint angle, both couples are sensed in the same direction.

The various cross groove joint components must be designed to provide the necessary joint angularity, axial travel, strength, and life requirements for a given application. The ultimate strength of the joint must be safely in excess of the maximum applied torque which can be developed by various loading modes. Initially, the shaft size is determined. Then the outer and inner races 132 and 134 and cage configuration 140 with an optimized ball size 136 and ball circle diameter can be designed to meet the various joint application parameters.

The outer races shown in FIGS. 11-13 illustrate three typical constructions (disc, flanged and closed end, respectively) in use. As indicated above, the outer race is a member with circumferentially spaced straight or helical ball grooves alternately inclined on the cylindrical inner surface and with drivable means of attachment. FIG. 14 shows an end view of a typical outer race describing the orientation of the circumferentially spaced and alternately inclined grooves. The inner race is an annular member with circumferentially spaced straight or helical ball grooves alternately inclined on the partly spherical or conical outer clearance surfaces and with internally splined drivable means of attachment. The inner race is held in position on the shaft spline with a retaining ring or rings. The cage is a ring-like member with concentric outer and inner cylindrical, or either partly spherical or conical surfaces, and with a circumferential series of openings or windows for maintaining the balls in a common plane.

When the joint is under static unloaded conditions, no means are required to maintain the cage concentric with the outer and inner races. Therefore, the effect of gravity may cause the cage to move radially into contact with one or both of the races. However, when torque is transmitted by the joint, the alternate balls are urged in opposite axial directions by the ball grooves. Opposite axial movement of these alternate balls is prevented by the cage, which maintains the balls in a common plane. Thus, the opposing axial forces tend to centralize the cage relative to the outer and inner races.

Because of design intent, or due to dimensional tolerances, the cage may lightly contact either the outer and/or inner races. Since the joint provides end motion, the balls positioned in the grooves of the two races and the cage must move axially relative to both races. Therefore, contact of the cage with the outer and/or inner races is not required for positioning of the balls or for proper functioning of the joint. In some ball type joints, the cage is used to position the balls in the constant velocity plane. In such joints, bearing surfaces must be provided between the cage and both races so that the positioning function of the cage can be accomplished.

When the cage design with partly spherical outer and inner surfaces is utilized, as shown in FIG. 10, its outer surface is in light contact with the cylindrical bore of the outer race. The cage inner surface limits the amount of axial stroke available in the joint by contacting the partly spherical or conical outer clearance surfaces of the inner race during extreme positions of end motion, and thus acting as an internal stop.

Joint 130 is adapted to be affixed to a rotary shaft 90 and includes a boot seal 142 which is affixable to the joint by one or more clamps 144. There is further provided a seal adapter 146 and an O-Ring Seal 148, the functionality of which are well known to those skilled in the art.

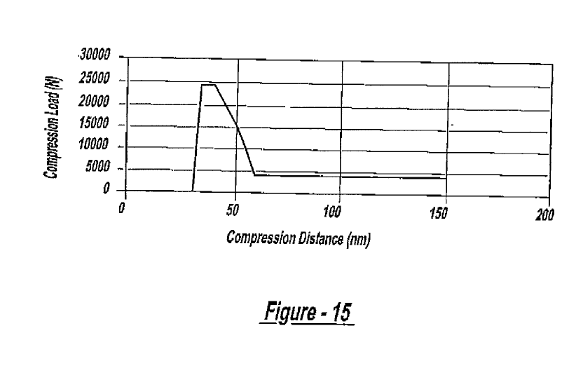

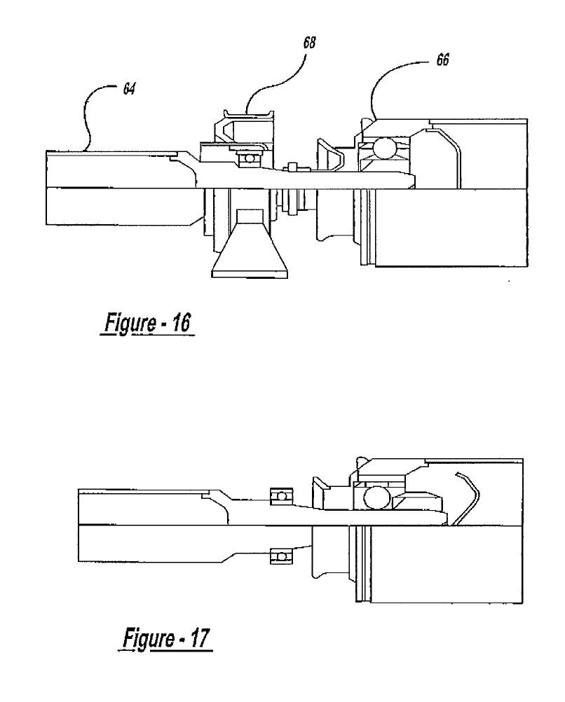

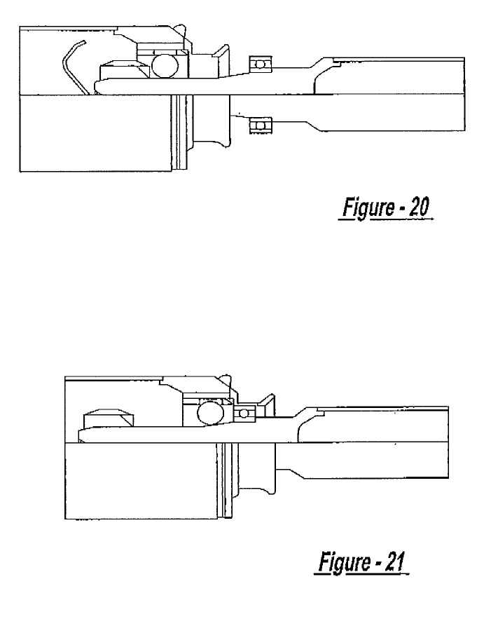

Referring now to FIGS. 15-20, the functionality of the propeller shaft assembly of the present invention, and more particularly, the propeller shaft sections will be described in further detail. Turning first to FIGS. 15-17 in a frontal crash, the front tube 64 will come to a stop with the engine/transmission in the initial stages of the collision. The rear plunging constant velocity joint 66 will take up the initial collision giving no resistance.

After the rear plunging joint 66 has used up its plunge travel, the joint will disassemble with very little load required. As the joint disassembles, the ball falls down and the grease cover is knocked out from the rear of the joint. After the grease cover is knocked out, the front section 64 can continue to plunge relative to the rear section 62 and the propshaft sections can telescope.

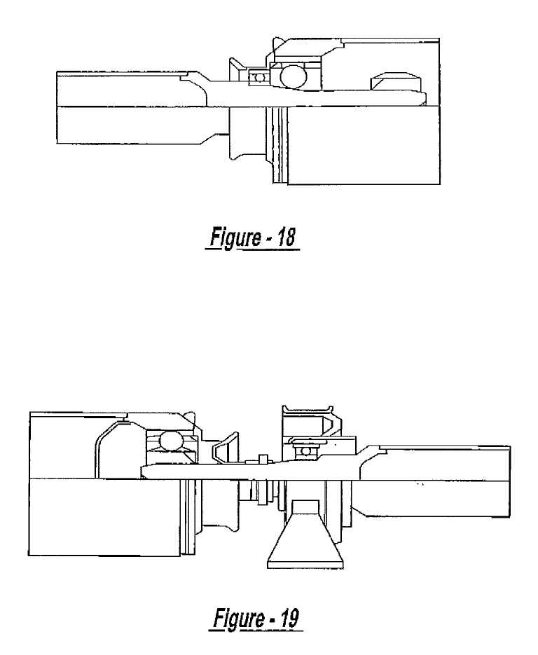

Similarly, as shown in FIGS. 18-20, the rear tube will accelerate with the rear of the vehicle in the initial stages of a rear collision. The VL joint will take up the initial collision giving no resistance.

After the front plunging joint 66 has used up its plunge travel, the joint 66 will similarly disassemble with very little load required. As the joint disassembles, the ball falls down and the grease cover is knocked out from the rear of the joint. After the grease cover is knocked out, the front section can continue to plunge relative to the rear and the propshaft sections can telescope.

FIG. 21 is a graph illustrating the relationship between compression load and compression distance in accordance with the operation of the present invention and in particular the functionality of the propeller shaft upon impact as described above. As shown, in keeping with the invention, there is initially no resistance to plunge, followed by a finite spike of load due to the disassembly of the joint followed by a compression distance at low load.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An crash optimized propeller shaft assembly, comprising:
a first propeller shaft section having a first plunging joint affixable thereto, the first plunging joint oriented in a first direction;
a second propeller shaft section having a second plunging joint affixable thereto, the second plunging joint oriented in a direction opposite the first direction; and
a connecting member for affixing the first and second propeller shaft sections.

2. An crash optimized propeller shaft assembly, comprising:
a first propeller shaft section having a first plunging joint affixable thereto;
a second propeller shaft section having a second plunging joint affixable thereto; and
a center bearing affixable to the first and second plunging joints,
wherein the plunging joints are oriented in opposing directions.

3. A crash optimized propeller shaft assembly, comprising:
a first propeller shaft section having a first end affixable to a drive line module and a second end affixable to a first plunging joint;
a second propeller shaft section affixable to the first propeller shaft section, the second propeller shaft section having a first end affixable to a power take-off unit and a second end affixable to a second plunging joint,
wherein the first and second plunging joints are oriented in opposing directions.
